(19) United States
(12) Patent Application Publication
(10) Pub. No.: US 2016/0138456 A1
(43) Pub. Date: May 19, 2016

(54) MOVEABLE, FUEL-LOCALIZED-POWER (FLP) PLANT

(71) Applicant: Willard Harvey Wattenburg, Chico, CA (US)

(72) Inventor: Willard Harvey Wattenburg, Chico, CA (US)

(21) Appl. No.: 14/198,487

(22) Filed: Mar. 5, 2014

Related U.S. Application Data
(60) Provisional application No. 61/773,408, filed on Mar. 6, 2013.

(51) Int. Cl. F01N 5/04; C09K 8/62

(52) U.S. Cl. CPC F01N 5/04; C09K 8/62

(57) ABSTRACT

A power plant can provide increased power from fossil fuels with reduced increase of the carbon burden. The plant is moveable and is located in a fossil fuel field, either a new field or a “depleted” field.” The CO₂ generated from the plant is compressed to a concentrated fluid and is re-injected into the underground strata from which the fossil fuel is extracted. This reduces the CO₂ emissions from the plant and uses the CO₂ to enhance production from the fuel field. Enormous amounts of oil and natural gas can be recovered from fields considered “depleted.” The infrastructure required to build and operate such carbon neutral moveable power plants can use known components. For “depleted” fields enhanced oil (or gas) recovery (EOR) procedures are highly developed and used throughout the world. The concentrated fluid can be a liquid that is re-injected.

### BACKGROUND

### Prior Art

The world is using extensive amounts of fossil fuels for electrical power generation, and, despite the advances and increasing use of renewable power sources (wind, solar, tides, etc.), it will be using fossil fuels for many decades at least. A main disadvantage of fossil fuel plants is that they emit copious quantities of carbon dioxide gas (CO₂), which is a carbon burden to the ecology and contributes to climate warming and its well-known disadvantages. Rapid conversion of coal burning plants to cleaner burning natural gas in countries such as the U.S. that have stores of natural gas can bring a large reduction of CO₂ emissions in those countries. But coal will continue to be the main source of power in many large economies, such as China and India. Oil will dominate as a source of power in the Middle East until they can convert to natural gas and/or nuclear. That is certainly decades away. In the meantime, major reductions in CO₂ worldwide, beyond natural gas conversion, will have to be made by other means if climate warming is to be reduced.

The greatest, immediate reduction in climate warming can be accomplished by replacing coal with natural gas in existing and future power plants that must use fossil fuel. Natural gas produces less than half the air pollution of coal. The next big reduction can be accomplished by building natural gas or oil burning Fuel-Localized-Power (FLP) plants since these emit almost no CO₂ into the atmosphere.

At the very least, the increase in the carbon burden is harmful to the ecology, population health, and atmospheric cleanliness and clarity. It is not possible to halt or reduce this increase unless we can at least stop the increase of CO₂ from new fossil fuel plants. Increased demand for power from fossil fuels beyond present levels must be met by carbon neutral schemes.

See “Carbon Dioxide Enhanced Oil Recovery”, National Energy Recovery Laboratory, US Dept of Energy (www.netl.doe.gov) and (http://en.wikipedia.org/wiki/Enhanced_oil_recovery).

### ADVANTAGES

Accordingly one or more advantages of various aspects of the present system are to reduce the carbon burden and CO₂ emissions from power plants. Another advantage is to be able to continue to utilize fossil fuel power sources while producing a decreased amount of CO₂ pollution. Further advantages of various aspects will be apparent from a consideration of the ensuing description and accompanying drawings.

### SUMMARY

A plant is provided that can provide increased power from fossil fuels with reduced increase of the carbon burden. The plant is made moveable and is located in a fossil fuel field, either in a new field or a “depleted” field.” The CO₂ generated from the plant is re-injected into the underground strata from which the fossil fuel is extracted. This provides a double benefit in that the CO₂ emissions from the plant are reduced or eliminated and the re-injected CO₂ can be used to enhance production from the fossil fuel field. Enormous amounts of oil and natural gas can be recovered in this manner from fields considered “depleted.” The infrastructure required to build and operate such carbon neutral moveable power plants can use known components. For “depleted” fields enhanced oil (or gas) recovery (EOR) procedures are highly developed and used throughout the world.

### DRAWINGS

FIG. 1 shows an improved portable electric power plant.

FIG. 2 shows a portable exhaust gas liquefier unit used in conjunction with the plant of FIG. 1.

### ABBREVIATIONS

EOR Enhanced Oil (or Gas) Recovery

FLP Fuel Localized Power

### DETAILED DESCRIPTION

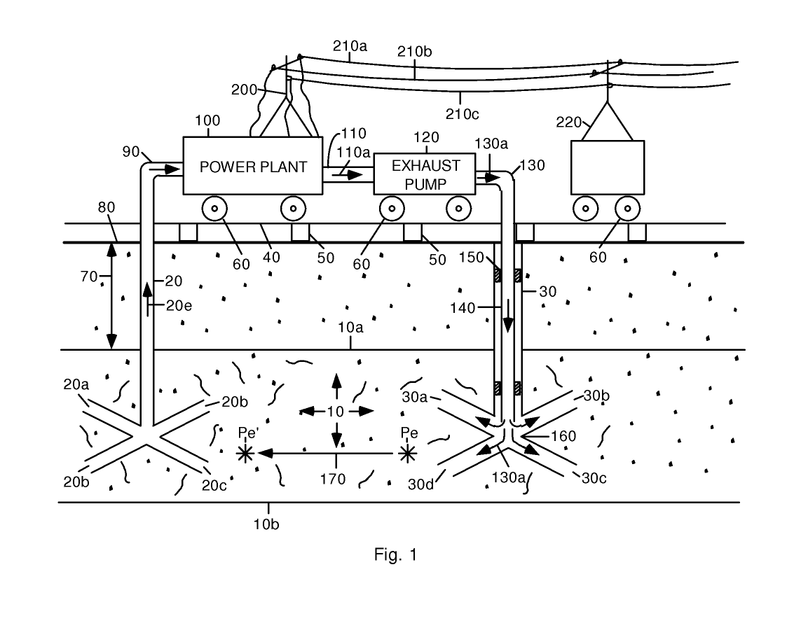

### FIG. 1—Power Plant With Exhaust Gas Recovery

FIG. 1 shows a portable electric power plant 100 with an exhaust gas recovery system. Plant 100 is mounted on a platform on wheels 60 that roll on a railroad type track runway 40 that is supported on the ground 80 by crossties 50. Such a power plant is moveable from one location to another without dismantling same. Since it is located in a fossil fuel field, it is called a Fuel Localized Plant (FLP). Plant 100 burns fossil fuel 20e (oil or gas) coming from a well 20 that extracts such fuel from an underground formation 10 that is located a distance 70 below ground 80. Formation 10 has an upper level 10a and a lower level 10b. Well 20 branches out with extensions 20a, 20b, 20c, and 20d. When plant 100 has burned all of the fuel in the ground beneath, it can then be moved to another location with a new supply of underground fossil fuel.

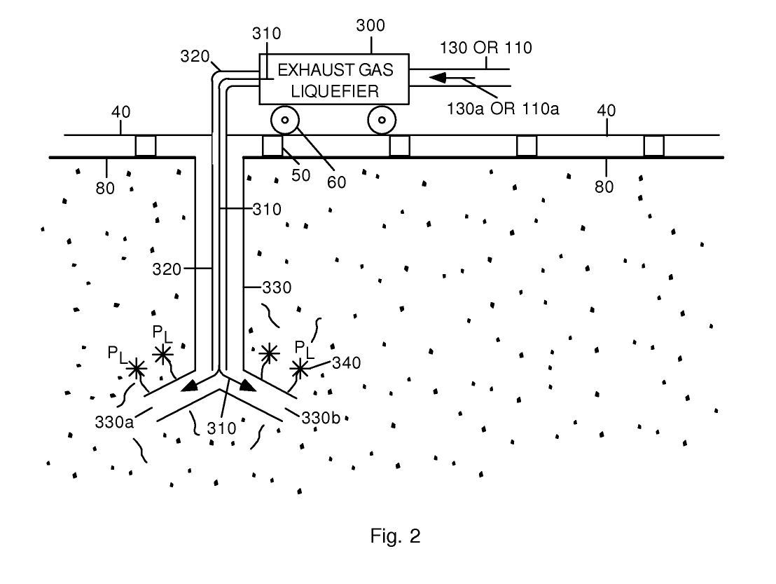

Plant 100 is connected to a track-mounted exhaust gas pump unit 120 by conduit 110 that transmits the exhaust gases 110a to a pump unit 120. Pump unit 120 compresses the exhaust gases 130a to some desirable pressure for re-injection into a nearby depleted or “companion” well 30 via an injection conduit 130. Injection conduit 130 is connected to a well pipe 140, which extends down into ground 80. Alternatively the exhaust gases can be sent to an on-site liquefier (FIG. 2) which will liquefy the CO₂ in such gases and re-inject it in liquid form. In either case the exhaust gas becomes a concentrated fluid (gas or liquid).

Well pipe 140 is surrounded by a protective well casing 30 that is closed and sealed by pressure seals 150 so that compressed exhaust gases 130a injected into the bottom 160 of well 30 cannot escape back up the annular space between casing 30 and pipe 140.

The compressed exhaust gases 130a injected into well 30 at bottom 160 create a pressure Pe in the area surrounding the bottom of well 30. A pressure profile 170 depicts the pressure drop Pe down to Pe′ from well 30 back to the area around well 20. The induced pressure Pe′ can enhance the production of well 20 by pushing fossil fuel products into well 20.

Power plant 100 produces electricity and transmits it over power lines 210a, 210b, and 210c that are connected to a transmission tower 200 mounted on power plant 100. These power lines are supported by moveable (portable) power line towers 220 that are connected to and pulled along by power plant 100 when it is moved on the track 40. Multiple track mounted towers 220 may follow power plant 100 such that the power lines reach back to and are connected to fixed transmission lines some distance from plant 100.

### FIG. 2—Use Of Liquefier

FIG. 2 shows a portable liquefier unit 300 that can be used to liquefy the CO₂ in the exhaust gases from the plant of FIG. 1. The unit is mounted on wheels 60 that roll on track 40 similar to the configuration of plant 100 in FIG. 1. Exhaust gases 110a or 130a enter unit 300, either directly from power plant 100 by conduit 110 or from the exhaust gas pump unit 120 by conduit 130. Liquefier 300 reduces the CO₂ in the exhaust gases to liquid form. CO₂ liquefies under reasonable compression (870 psi) at room temperature. The other exhaust gases will not liquefy at this pressure but can go along with the liquefied CO₂ if no attempt is made separate them out. The liquid CO₂ is then re-injected into well 330 at sufficient pressure for enhanced fossil fuel recovery in adjacent wells, and/or hydraulic fracturing (fracking) existing well channels 310a and 310b. The liquefied CO₂ is used primarily for enhancing recovery by pressurizing strata to squeeze out more oil or gas as well as hydraulic fracturing when needed. Excess CO₂ from plant 100 can be re-injected into depleted wells as the power plant moves on to new producing wells for fuel.

### Benefits

The FLP concept, in its most effective form, turns fossil fuel, considered the most environmentally “dirty” energy, into green energy in the sense that no carbon is injected into the atmosphere by the burning of fossil fuels in an FLP power plant. The FLP power plant also opens up enormous new supplies of fossil fuel in “depleted” oil-gas fields by providing a local supply of CO2 that can be used to enhance the recovery of fossil fuels from the depleted fields.

The FLP concept alleviates many of the major problems created by fixed-location power plants that are the main sources of air pollution and the increasing amounts of CO₂ in the atmosphere. The thousands of existing coal, natural gas and oil burning power plants will not be replaced in less than many decades, so there is ample use for the FLP. The important first step to reducing climate warming is to at least reduce the increase of CO₂ injection into the atmosphere as electrical energy demands increase worldwide. That means stopping the building of new conventional fossil fuel power plants that inject CO₂ into the atmosphere.

The FLP concept described allows the use of enormous supplies of fossil fuels still in the ground as well as the use of new supplies of natural gas to produce carbon-free power plants that compete with the best of the “green” energy sources being developed at much greater cost per unit of electricity produced.

The entire infrastructure needed to build an FLP exists today with available components. All the major components needed are being used for a variety of other purposes. No new groundbreaking research results are necessary. An FLP can be built and installed in most any fossil fuel field in less than a year. Compare this to the hundreds of millions being spent to test just a few CO₂ sequestration schemes that could, at best, serve only a small percentage of the fixed-site power plants in the world.

An FLP can alternatively be used to re-inject its exhaust gases into “sequester wells” surrounding nearby production wells that supply fuel to the power plants. The CO₂ injected into nearby “sequester wells” can be used to create Enhanced Oil Recovery (EOR) to force trapped oil to the surface for use by the FLP. Thus, FLPs can be carbon neutral in the ideal case, or they can approach this goal. They can compete with other much more expensive “green” energy supplies as far a low impact on climate warming.

The FLP concept accomplishes several important objectives and exploits existing infrastructure that is already highly developed for the following reasons
Most of the CO₂ produced by the present FLP plant is not released into the atmosphere. It is captured in the nearby underground strata that are vacated by the fossil fuel extracted to power the FLP.
A estimated 40 to 60% of all of the oil in “depleted” oil fields is still underground. The FLP allows the recovery and use of an enormous amount of this “remaining” oil by using the CO₂ produced by the FLP for Enhanced Oil Recovery (EOR). Experts have estimated that the amount of trapped oil that can be recovered at reasonable cost with local sources of CO₂ for EOR is enough to provide all the electrical power for the U.S. for the next fifty years. Add to this the enormous amount of natural gas available and we can meet the electrical needs of the nation indefinitely.
The cost of exhaust gas compression (CO₂) for local re-injection is offset by the reduction in the cost of transporting or importing foreign CO₂ for EOR. The cost of delivered CO₂ is a major expense and risk for EOR operations. The cost of CO₂ can be 25 to 50% of the cost per barrel of oil produced by EOR when the CO₂ must be imported. (See www.netl.doe.gov for Carbon Dioxide Enhanced Oil Recovery). The enormous expense of continuous supplies of CO₂ imported from distant sources is mostly eliminated with a FLP that produces its own CO₂ on site.
Depleted oil and natural gas fields already have a great deal of transportation and power line infrastructure in place. The existing bore holes in a depleted field will usually be sufficient to begin an EOP operation with an installed FLP.
The main requirement for constructing a FLP in an existing depleted oil of natural gas field will be the laying of railroad tracks to support FLP assembly as it moves slowly from depleted to new fossil fuel areas. (The track structure that allowed transport of the Space Shuttle to the launch pad is more than adequate to handle a FLP having a generating capacity of 1000 megawatts.) There are already portable versions of natural gas and oil powered peaker power plants of 300 megawatts and greater capacity. One of these can be transported on a single, standard railroad track bed. Because high-speed movement is not necessary, an adequate track bed can be installed over rolling terrain without great expense. The FLP might move only once every few months or once every few years. Existing roadways that were developed during peak production in most any fossil fuel field are adequate for laying the tracks to support a FLP and its moveable power line connections.
Peaker power plants fueled by natural gas or oil already exist with capacities of 300 megawatts or more. These are portable in the sense that they can be mounted on rail cars or wheeled transporters. They are designed to be set up and turned on in a matter of weeks, not years. These plants can be augmented with portable waste heat co-generation units that enhance generation efficiency and/or provide energy for other purposes such as CO₂ capture and compression for reinjection. I believe that the cogeneration alone will be sufficient to power the separators and compressors that capture and re-inject the FLP CO2 for EOR and sequestration. The cost of CO₂ processing at a FLP will be less than 15% of the potential power output of a normal combined cycle cogeneration power plant with no sequestration of CO₂. This should be compared to the projected 50 to 100% increased cost per kilowatt-hour for sequestering CO2 from conventional power plants.

### Examples of Current EOR Projects

In Canada, a CO₂-EOR project has been established by CenovusEnergy (see at the Weyburn Oil Field in southern Saskatchewan. The project is expected to inject a net 18 million tons of CO₂ and recover an additional 130 million barrels (21,000,000 m³) of oil, extending the life of the oil field by 25 years. There is a projected 26+ million tonnes (net of production) of CO₂ to be stored in Weyburn, plus another 8.5 million tonnes (net of production) stored at the Weyburn-Midale Carbon Dioxide Project, resulting in a significant net reduction in atmospheric CO₂. That's the equivalent of taking nearly 7 million cars off the road for a year. Since CO₂ injection began in late 2000, the EOR project has performed largely as predicted. Currently, some 1600 m³ (10,063 barrels) per day of incremental oil is being produced from the field.

### Potential for EOR in United States

The US has been using EOR for several decades. For over 30 years, oil fields in the Permian Basin have implemented CO₂ EOR using naturally sourced CO₂ from New Mexico and Colorado. The Department of Energy (DOE) has estimated that full use of “next generation” CO₂-EOR in United States could generate an additional 240 billion barrels (38 km³) of recoverable oil resources. Developing this potential would depend on the availability of commercial CO₂ in large volumes, which could be made possible by widespread use of carbon capture and storage. For comparison, the total undeveloped US domestic oil resources still in the ground total more than 1 trillion barrels (160 km³), most of it remaining unrecoverable. The DOE estimates that if the EOR potential were to be fully realized, state and local treasuries would gain $280 billion in revenues from future royalties, severance taxes, and state income taxes on oil production, aside from other economic benefits.

Liquid Carbon Dioxide Superfluids

Carbon dioxide is particularly effective in reservoirs deeper than 2,000 ft., where the injected CO₂ will be in a supercritical state. In high-pressure applications with lighter oils, CO₂ is miscible with the oil, with resultant swelling of the oil, and reduction in viscosity, and possibly also with a reduction in the surface tension with the reservoir rock. In the case of low-pressure reservoirs or heavy oils, CO₂ will form an immiscible fluid, or will only partially mix with the oil. Some oil swelling may occur, and oil viscosity can still be significantly reduced.

In these applications, between one-half and two-thirds of the injected CO₂ returns with the produced oil and is usually re-injected into the reservoir to minimize operating costs. The remainder is trapped in the oil reservoir by various means. Carbon dioxide as a solvent has the benefit of being more economical than other similarly miscible fluids such as propane and butane.

The thousands of existing coal, natural gas and oil burning power plants will not be replaced in less than many decades. The important first step to reducing climate warming is to at least stop the increase of CO₂ injection into the atmosphere as electrical energy demands are increasing worldwide. That means stopping the building of new conventional fossil fuel power plants that inject CO₂ into the atmosphere.

The FLP concept described allows the use of enormous supplies of fossil fuels still in the ground in “depleted fields” as well as new supplies of natural gas to produce carbon-free power plants that compete with the best of the “green” energy sources being developed at much greater cost per unit of electricity produced.

Fortunately, enormous supplies of natural gas are being developed close to major urban centers in the northeast of the U.S. Here, FLP's can be built in the middle of the fossil fuel fields. The FLP's will also be close to the power demand locations and electrical transmission lines that fed these areas.

The recoverable oil and natural gas in the depleted fields of the U.S. alone can supply the power needs of the country for many decades. These depleted fields have most of the transportation infrastructure in place (and, in many cases, the electrical power transmission) that is required to construct and operate moveable power plants at minimal expense and in short time.

The additional cost for new power transmission lines and moveable power plant equipment is more than offset by the savings in cost for carbon sequestration that is otherwise out of the question of most fixed-base power plants.

The ideal way to reduce atmospheric CO₂ from burning fossil fuels extracted from the ground is to return the carbon to where it came from. Put the CO₂ back in the ground. However, that is simply not possible at reasonable expense for the vast majority of land-based power plants burning fossil fuels. The biggest impediment to carbon sequestration is the mere fact that most fixed-base power plants are located in urban and industrialized areas, near the demand for power. These are generally not the areas that are best suited for sequestration of the CO₂ produced by the power plants. The obvious path to CO₂ reduction is to locate new fossil fuel plants near the fuel sources that are good sequestration sites.

### Conclusion, Ramifications, And Scope

Accordingly the reader will see that, according to one or more aspects, I have provided a power plant that can produce liquid CO₂ for EOR (Enhanced Oil Recovery), without the need to transport the CO₂ to the wells or to produce CO₂ in central facilities and deliver it over long pipelines or by truck/train. Power plants that can sequester CO₂ can be provided adjacent the locations best suited for CO₂ sequestration, such as ocean areas and oil/gas fields. The present FLP system can be located at the site of fossil fuel recovery. This provides fuel for a power plant close to the plant and CO₂ from the power plant that can be used for EOR by be re-injecting the exhaust CO₂ into the depleted oil or gas wells that supplied the fuel to the power plant as the power plant moves forward to new wells.

While the above description contains many specificities, these should not be construed as limitations on the scope, but as exemplifications of some present embodiments. Many other ramifications and variations are possible within the teachings. For example the power plant can be mounted on rubber or other resilient wheels without tracks so that it can be easily moved on flat ground without tracks. The power plant can be mounted on a floating watercraft (barge or ship) to facilitate movement thereof.

Thus the scope should be determined by the appended claims and their legal equivalents, and not by the examples given.

1. An improved power plant for generating electricity from fossil fuels, comprising:
a. an electric generating plant that can convert fossil-fuel supplied to such plant into electrical power, such plant emitting exhaust gases comprising carbon dioxide,
b. said power plant being moveable from one location to another without dismantling said power plant,
c. a compressor for receiving said exhaust gases from said power plant and compressing said exhaust gases into a compressed gas or liquid, hereafter concentrated fluid
d. a conduit arranged to receive the resultant compressed concentrated fluid, said conduit extending down below the surface of the earth to an underground location so that said conduit can inject said concentrated fluid into said underground location,
whereby said concentrated fluid will be stored at said underground location and will not be sent into the atmosphere.

2. The power plant of claim 1 wherein said fossil fuel supplied to said power plant is obtained from said underground location below the surface of the earth.

3. The power plant of claim 2 wherein said compressor is arranged to supply said concentrated fluid at a pressure that will enhance the recovery of said fossil fuel at said underground location, thereby to promote more fuel production from said underground location.

4. The power plant of claim 1 wherein said fossil fuel supplied to said power plant is obtained from said underground location below the surface of the earth and said compressor is arranged to liquefy said carbon dioxide in said exhaust gases and supply said liquefied carbon dioxide to be used to enhance the recovery of said fossil fuel at said underground location or to hydraulically fracture formations at said underground location to release fossil fuels that otherwise would not be recovered.

5. The power plant of claim 1 wherein said power plant is mounted on wheels to facilitate movement thereof from one location to another.

6. The power plant of claim 5 wherein said wheels are railroad wheels and further including railroad tracks on which said wheels are engaged to facilitate movement of said power plant.

7. An improved power plant for generating electricity from fossil fuels, comprising:
a. an electric generating plant that can convert fossil-fuel supplied to such plant into electrical power, such plant emitting exhaust gases comprising carbon dioxide,
b. a first conduit for supplying said fossil fuel from an underground location below the surface of the earth under said power plant to said power plant.
c. said power plant being moveable from one location to another without dismantling said power plant,
d. a compressor for receiving said exhaust gases from said power plant and compressing said exhaust gases into concentrated fluid,
e. a second conduit arranged to receive the resultant concentrated fluid, said conduit extending down below the surface of the earth to an underground location so that said conduit can inject said concentrated fluid into said underground location,
whereby said exhaust gases will be stored at said underground location and will not be sent into the atmosphere.

8. The power plant of claim 7 wherein said compressor is arranged to supply said concentrated fluid at a pressure such that it can be used for enhanced recovery of fossil fuels or used for fracking operations at said underground location, thereby to promote more fuel production from said underground location.

9. The power plant of claim 7 wherein said compressor is arranged to liquefy said carbon dioxide in said exhaust gases and supply said liquefied carbon dioxide for enhanced fossil fuel recovery or for fracking operations at said underground location.

10. The power plant of claim 7 wherein said power plant is mounted on wheels to facilitate movement thereof from one location to another.

11. The power plant of claim 7 wherein said wheels are railroad wheels and further including railroad tracks on which said wheels are engaged to facilitate movement of said power plant.

12. An improved power plant for generating electricity from fossil fuels, comprising
a. an electric generating plant that can convert fossil-fuel supplied to such plant into electrical power, such plant emitting exhaust gases comprising carbon dioxide,
b. a first conduit for supplying said fossil fuel from an underground location below the surface of the earth under said power plant to said power plant.
c. said power plant being moveable from one location to another without dismantling said power plant,
d. a compressor for receiving said exhaust gases from said power plant and compressing said exhaust gases into a concentrated fluid,
e. a second conduit arranged to receive the resultant concentrated fluid, said conduit extending down below the surface of the earth to an underground location so that said conduit can inject said concentrated fluid into said underground location,
f. said compressor being arranged to supply said concentrated fluid at a pressure that will hydraulically fracture said fossil fuel at said underground location, thereby to promote more fuel production from said underground location, whereby said exhaust gases will be stored at said underground location and will not be sent into the atmosphere.

13. The power plant of claim 12 wherein said compressor is also arranged to liquefy said carbon dioxide in said exhaust gases and supply said liquefied carbon dioxide for enhanced fossil fuel recovery or for fracking operations at said underground location.

14. The power plant of claim 12 wherein said power plant is mounted on wheels to facilitate movement thereof from one location to another.

15. The power plant of claim 12 wherein said wheels are railroad wheels and further including railroad tracks on which said wheels are engaged to facilitate movement of said power plant.
